(19) United States
(12) Patent Application Publication
(10) Pub. No.: US 2008/0107389 A1
(43) Pub. Date: May 8, 2008

(54) SYNC SEPARATOR FOR SEPARATING SYNC SIGNAL TO FOLLOW FLUCTUATIONS IN VIDEO SIGNAL

(75) Inventor: Hiroki OGO, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 11/927,723

(22) Filed: Oct. 30, 2007

(30) Foreign Application Priority Data
Nov. 6, 2006 (JP) 2006-300455

(51) Int. Cl. H04N 5/94

(52) U.S. Cl. 386/48

(57) ABSTRACT

In a sync separator, a comparator extracts two composite sync signals, based on two reference levels for a composite video signal. Two sync separation determiners separate sync signals from each extracted composite sync signal, and determine whether or not the separated sync signals include dropout. The results of determination are developed as two sets of separation determination signal, based on which a level controller generates the two reference levels to be supplied to the comparator. One of the reference levels is sequentially changed in phase differently from the other reference level. The two reference levels are fixedly set responsive to normal separation of the sync signals. The reference level, suffering dropout, is changed responsive to dropout in the sync signals. A selector selects either one of the two composite sync signals obtained, based on the two sets of separation determination signal, and outputs the selected composite sync signal.

### BACKGROUND OF THE INVENTION

1. Field of the Invention

The present invention relates to a sync signal separator, and more particularly to a sync signal separator for separating a sync signal from a composite video signal handled in a television system.

2. Description of the Background Art

Assume that a television broadcast signal is received in a territory of weak electrical field. If the received television broadcast signal is demodulated, a composite video signal is produced, corrupted by a noise. At this time, at least either of the sync chip and pedestal levels in the composite video signal received fluctuates. Hence, the sync separator is unable to separate sync signals properly from the produced composite video signal, with the result that disturbs are caused in a reproduced image. Japanese Patent No. 3755274 discloses a sync signal separator in which the signal level for separating the sync signal from the composite video signal is sequentially changed each field period of time in order to cope with fluctuations in the sync chip and/or pedestal levels.

In the sync signal separator, disclosed in Japanese Patent No. 3755274, the signal level for separating the sync signal is thus sequentially changed every field period. The period until the signal level takes its proper value tends to be protracted depending on fluctuations in the sync chip and/or pedestal levels. That period may extend even several fields period. During this period, the reproduced picture is displayed on the monitor screen of a television receiver while disturbed.

### SUMMARY OF THE INVENTION

It is therefore an object of the present invention to provide a sync separator which is able to separate the sync signal, even when a composite video signal fluctuates, in keeping with fluctuations.

In accordance with the present invention, a sync separator for separating a sync signal from a composite video signal comprises a comparator, a first sync separation determiner, a second sync separation determiner, a level controller and a selector. The comparator extracts first and second composite sync signals with respect to first and second reference levels for the composite video signal. The first sync separation determiner separates the sync signal from the composite sync signals extracted, and determines whether or not there is dropout in the sync signal separated to develop the result of determination as a first separation determination signal. The second sync separation determiner separates the sync signal from another of the composite sync signals extracted, and determines whether or not there is dropout in the sync signal separated to develop the result of determination as a second separation determination signal. The level controller generates the first and second reference levels, based on the first and second separation determination signals, and supplies the first and second reference levels generated to the comparator. The selector is responsive to the two separation determination signals to select either one of the first and second composite sync signals to output the one composite sync signal selected. The level controller causes the second reference level to be sequentially changed so that the phase state of the second reference level will be different from that of the first reference level, and fixedly sets the first and second reference levels responsive to normal separation of the sync signals. The selector causes the reference level suffering from dropout in the sync signal to be changed responsive to the dropout in the sync signal.

In the sync separator, specifically, the comparator extracts, based on the two reference levels for the composite video signal, first and second composite sync signals, and the two sync separation determiners separate sync signals from one and the other of the extracted composite sync signals. The sync separation determiners determine whether or not there is dropout in the separated sync signals. The result of determination is developed as two sets of separation determination signals. Based on the two sets of separation determination signals, the level controller generates the two reference levels to be supplied to the comparator. One of the reference levels is sequentially changed so that the phase state thereof will differ from that of the other reference level. The two reference levels are fixedly set responsive to normal separation of the sync signal. The reference level, suffering dropout, is changed responsive to dropout in the sync signal. A selector is responsive to the two sets of the separation determination signals to select either one of the two composite sync signals obtained to output the so selected composite sync signal.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the configuration of a sync separator of an embodiment according to the present invention;

FIG. 2 is a schematic block diagram showing the configuration of a comparator circuit in the comparator shown in FIG. 1;

FIG. 3 shows the timing relationship between the output signal and level positions in an input signal supplied to the comparator shown in FIG. 1;

FIG. 4 is a schematic block diagram showing the configuration in the sync separation determiner shown in FIG. 1;

FIG. 5 is a schematic block diagram showing a level control circuit in the level controller shown in FIG. 1;

FIG. 6 is a schematic block diagram showing the selector shown in FIG. 1;

FIG. 7 is a timing chart showing the relationship between the input signal supplied to the comparator shown in FIG. 1 and the output signals obtained with level changes in the input signal in relation with reference levels;

FIG. 8 is a timing chart useful for understanding how two reference levels used in the sync separator shown in FIG. 1 fluctuate with time;

FIG. 9 is a schematic block diagram showing essential portions of a sync separator of an alternative embodiment according to the present invention;

FIG. 10 is a graph useful for understanding the principle of giving a determination on sync separation based on possible dropout in the horizontal sync signal in the alternative embodiment shown in FIG. 9;

FIG. 11 is a schematic circuit diagram showing a circuit configuration of the selector used in the alternative embodiment shown in FIG. 9; and

FIG. 12 is a timing chart useful for understanding the relationship between the input signal supplied in the modification shown in FIG. 9 and output signals obtained in relation with positional changes of the reference levels in the input signal.

### DESCRIPTION OF THE PREFERRED EMBODIMENTS

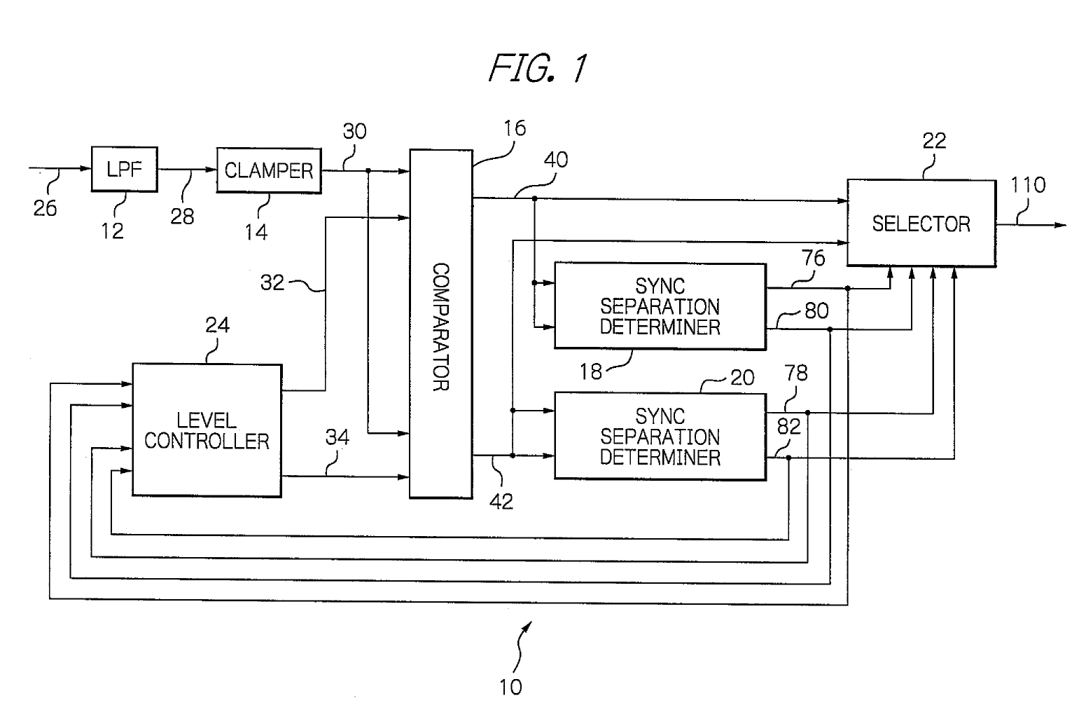

With reference to the accompanying drawings, preferred embodiments of the present invention will be described in detail. Referring first to FIG. 1, in a preferred embodiment of a sync separator 10, a comparator 16 extracts two composite sync signals 40 (SC1) and 42 (SC2), based on two reference levels 32 (SL1) and 34 (SL2) for a composite video signal, and two sync separation determiners 18 and 20 separate sync signals from one and the other of the extracted composite sync signals. The two sync separation determiners 18 and 20 decide on whether or not there is dropout in the separated sync signals. The results of determination are developed as two sets 76-80 and 78-82 of separation determination signals. Based on these two sets of separation determination signals, the level controller 24 generates the two reference levels 32 (SL1) and 34 (SL2) to be supplied to the comparator 16. One 34 (SL2) of the reference levels is sequentially changed so that the phase states thereof will differ from those of the other reference level 32 (SL1). The two reference levels 32 (SL1) and 34 (SL2) are fixedly set upon a normal separation of the sync signals. The reference level, suffering dropout, is changed or adjusted responsive to dropout in the sync signal. A selector 22 selects either one of the two composite sync signals 40 (SC1) and 42 (SC2) obtained, based on the two sets 76-80 and 78-82 of the separation determination signals, and outputs the so selected composite sync signal. It is possible in this manner to separate the sync signal in a short time even on occurrence of fluctuations in the composite video signal.

The present embodiment is directed to the sync separator 10 to which the present invention is applied. Parts or components not directly relevant to understanding the present invention are not shown nor described. In the description, signals are designated by reference numerals of connections on which appear the signals.

Still referring to FIG. 1, the sync separator 10 includes a low-pass filter (LPF) 12 and a clamper 14, in addition to the comparator 16, sync separation determiners 18 and 20, selector 22 and level controller 24, which are interconnected as illustrated.

The low-pass filter 12 has the function of removing unneeded chroma signal and noise components in the high frequency range in an input composite video signal 26. The low-pass filter 12 produces a composite video signal 28, freed of the chroma signal and noise components in the high frequency range. A composite video signal 28 produced is output to the clamper 14.

Meanwhile, in case the composite video signal 26 has been demodulated from a television broadcast signal, received in a territory of weak electrical field where the incoming signal state is bad, such as where the electrical field intensity is low, the composite video signal 26, supplied to the low-pass filter 12, suffers from severe distortion in waveform. Moreover, at least either one of the sync chip and pedestal levels has been subjected to fluctuations.

The clamper 14 has the function of clamping the sync chip level of the composite video signal supplied at a predetermined sync chip level. The clamper 14 produces, by this function, a composite video signal 30, freed of fluctuation in d.c. (direct current) level of the composite video signal 28. There are left sync chip level fluctuations in the composite video signal 30.

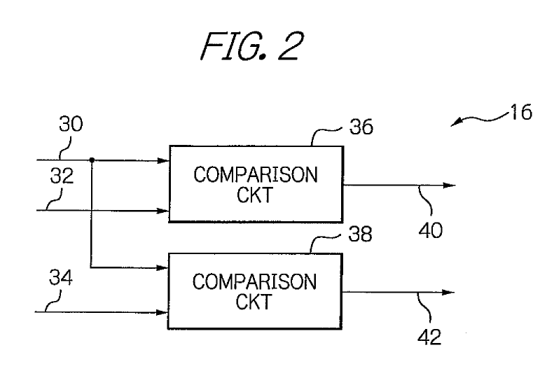

The comparator 16 has the function of relatively comparing the intensity of the composite video signal 30 with a reference level 32 (first level: SL1) supplied from the level controller 24. The comparator 16 also has the function of relatively comparing the intensity of the composite video signal 30 with another reference level 34 (second level: SL2) supplied from the level controller 24. The comparator 16 includes comparator circuits 36 and 38, FIG. 2, which are interconnected as shown.

The one comparison circuit 36 separates portions of the composite video signal 30 that are smaller than the reference level signal 32 to produce the signal 40 (SC1). The other comparison circuit 38 separates portions of the composite video signal 30 that are smaller than the reference level signal 34 to produce the signal 42 (SC2).

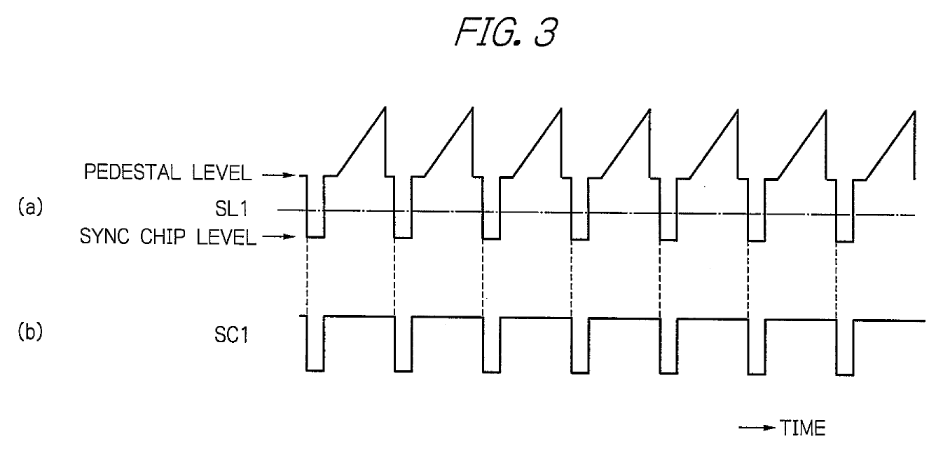

The processing by the comparator 16 will be understood from a timing chart of FIG. 3. In FIG. 3, line (a) shows the relationship of the sync chip and pedestal levels in the waveforms of the input signals 40 and 42. The signals 40 and 42 are signals which will, when properly separated by the comparator 16, be composite sync signals. FIG. 3, line (b), shows an output signal 40 (SC1) from the comparator 16 correspondingly to the waveforms of the input signals 40 and 42.

It should be noted that the reference level signals 32 and 34 are not of constant intensity, but are controlled by the level controller 24 to an optimum magnitude to separate sync signals, as will be apparent subsequently. The reason is that, since the composite video signal 30 contains residual fluctuations of the sync chip level, there may be cases wherein, if the reference level signal 32 is of fixed intensity, dropout in the sync signal may practically occur in an output signal 40 of the comparator 16.

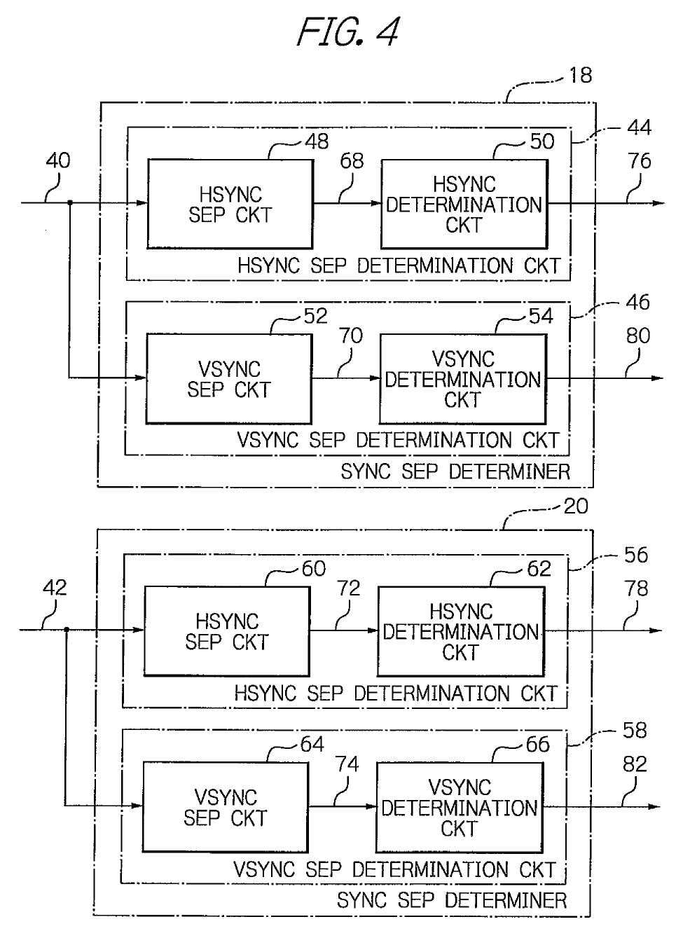

Reverting to FIG. 1, the sync separation determiners 18 and 20 have the function of separating sync signals from the signals supplied thereto, in the horizontal and vertical directions, to determine a possible dropout in the separated sync signals. The one sync separation determiner 18 is, as shown in FIG. 4, made up of a horizontal sync signal separation determination circuit 44 and a vertical sync signal separation determination circuit 46 which are interconnected as illustrated. The horizontal sync signal separation determination circuit 44 has the function of separating the sync signal in the horizontal direction and determining a possible dropout in the separated horizontal sync signal, and is made up of a horizontal sync separation circuit 48 and a horizontal sync determination circuit 50 interconnected as shown. The vertical sync signal separation determination circuit 46 has the function of separating the sync signal in the vertical direction and determining a possible dropout in the separated vertical sync signal, and is made up of a vertical sync separation circuit 52 and a vertical sync determination circuit 54 interconnected as depicted.

The other sync separation determination 20 has the same function as the sync separation determiner 18, and includes a horizontal sync separation determination circuit 56 and a vertical sync separation circuit 58 interconnected as illustrated. The horizontal sync separation determination circuit 56 includes a horizontal sync separation circuit 60 and a horizontal sync determination circuit 62 interconnected as shown. The vertical sync separation determination circuit 58 includes a vertical sync separation circuit 64 and a vertical sync determination circuit 66 interconnected as shown.

The horizontal sync separation circuits 48 and 60, and the vertical sync separation circuits 52 and 64 may each be of circuit configurations well-known to those skilled in the art. The horizontal sync separation circuit 48 and the vertical sync separation circuit 52 separate the signal 40, produced by the comparator 16, into a horizontal sync signal 68 (SH1) and a vertical sync signal 70 (SV1), respectively, and output the so separated horizontal sync signal 68 (SH1) and vertical sync signal 70 (SV1) to the horizontal sync determination circuit 50 and to the vertical sync determination circuit 54, respectively. The horizontal sync separation circuit 60 and the vertical sync separation circuit 64 separate the signal 42, produced by the comparator 16, into a horizontal sync signal 72 (SH2) and a vertical sync signal 74 (SV2), respectively, and output the so separated horizontal sync signal 72 (SH2) and vertical sync signal 74 (SV2) to the horizontal sync determination circuit 62 and to the vertical sync determination circuit 66, respectively.

The horizontal sync determination circuits 50 and 62 have the function of determining possible substantial dropout in horizontal sync signal from one field period to another. The horizontal sync determination circuits 50 and 62 each include a counter, not shown, for counting the number of horizontal sync signals, included within a predetermined period, from one field period of the composite video signal to another, and determine possible substantial dropout in the horizontal sync signal, from one field period to another, based on a count established in the counters.

When the horizontal sync determination circuit 50 has determined that there is no dropout in the horizontal sync signal, it outputs an output signal 76 of the logic level “1” to the selector 22. When the horizontal sync determination circuit 50 has determined that there is dropout in the horizontal sync signal, it outputs an output signal 76 of the logic level “0” to the selector 22. When the horizontal sync determination circuit 62 has determined that there is no dropout in the horizontal sync signal, it outputs an output signal 78 of the logic level “1” to the selector 22. When the horizontal sync determination circuit 62 has determined that there is dropout in the horizontal sync signal, it outputs an output signal 78 of the logic level “0” to the selector 22.

The vertical sync determination circuit 54 has the function of determining the period of repetition of the vertical sync signal 70. Specifically, the vertical sync determination circuit 54 includes a circuit, also not shown, for determining the period of repetition of the vertical sync signal 70 supplied thereto. This detection circuit detects substantial dropout in the vertical sync signal. When the vertical sync determination circuit 54 has determined that there is no dropout in the vertical sync signal, it outputs an output signal 80 of the logical level “1” to the selector 22. When the vertical sync determination circuit 54 has determined that there is dropout in the vertical sync signal, it outputs an output signal 80 of the logical level “0” to the selector 22.

Similarly, the vertical sync determination circuit 66 has the function of determining the period of repetition of the vertical sync signal 74. Specifically, the vertical sync determination circuit 66 includes a circuit for determining the period of repetition of the vertical sync signal 74 supplied thereto. This detection circuit detects substantial dropout in the vertical sync signal. When the vertical sync determination circuit 66 has determined that there is no dropout in the vertical sync signal, it outputs an output signal 82 of the logical level “1” to the selector 22. When the vertical sync determination circuit 66 has determined that there is dropout in the vertical sync signal, it outputs an output signal 82 of the logical level “0” to the selector 22.

Reverting to FIG. 1, the horizontal sync determination circuits 50 and 62, and the vertical sync determination circuits 54 and 68 output determination signals 76, 78, 80 and 82, which stand for the results of the sync determination, to the selector 22, while supplying the signals to the level controller 24.

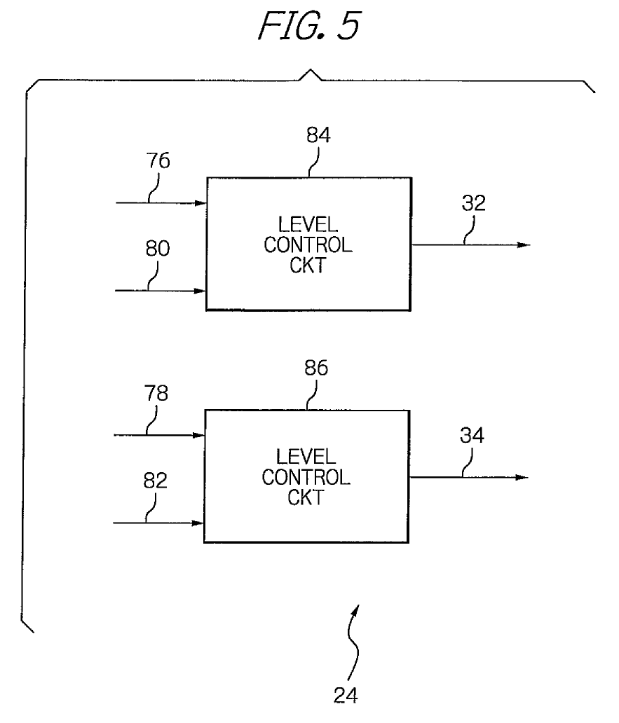

The level controller 24 has the function of changing or adjusting the reference level signal 32 (SL1), to be supplied to the comparator 16, responsive to the determination signals 76 and 80, and the function of changing, i.e. adjusting, the reference level signal 34 (SL2), to be supplied to the comparator 16, responsive to the determination signals 78 and 82. The level controller 24 includes level control circuits 84 and 86, as shown in FIG. 5. In order to permit the comparator 16 to properly separate composite sync signals, the determination signals 76 and 78 are fed back to the level control circuit 84, whilst the determination signals 78 and 82 are fed back to the level control circuit 86.

Specifically, the level control circuit 84 sequentially changes the reference level signal 32 (SL1), each field period, and fixedly sets the reference level signal 32 at such a level for which the determination signals 76 and 80 indicate no dropout in the sync signal. The level control circuit 86 fixedly sets the reference level signal 34 at such a level for which the determination signals 78 and 82 indicate no dropout in the sync signal. The level control circuits 84 and 86 of the level controller 24 cause the reference level signals 32 (SL1) and 34 (SL2) to be changed continuously between the minimum level SL_min and the maximum level SL_max, both of which are set responsive to fluctuations in the sync chip level in the composite video signal 30.

In the sync separator 10, the reference level signals 32 and 34 are sequentially changed, so that the phase states of the reference level signals 32 and 34 will be different from each other, from one field period to another, in order to permit proper separation of composite sync signals within a shorter time, as will be described subsequently.

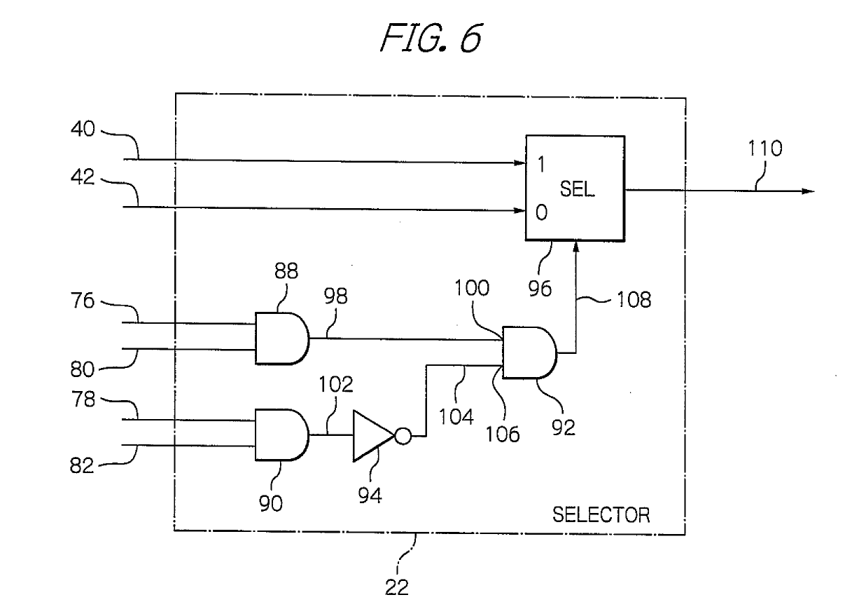

Reverting to FIG. 1, the selector 22 has the function of selecting either one of the composite sync signals 40 (SC1) and 42 (SC2), produced by the comparator 16, as being a proper signal. Referring to FIG. 6, the selector 22 includes AND gates 88, 90 and 92, an inverter 94 and a selection circuit 96, which are interconnected as illustrated.

The AND gate 88 receives the determination signals 76 and 80 to execute a logical product operation on the input determination signals to produce an output signal 98. The AND gate 88 routes the so produced output signal 98 to the one input port 100 of the AND gate 92. The AND gate 90 receives the determination signals 78 and 82 to execute the logical product operation on the input determination signals to produce an output signal 102. The AND gate 90 routes the so produced output signal 98 to an inverter 94. The inverter 94 inverts the level of the output signal 98 received to route the so inverted output signal 104 to the other input port 106 of the AND gate 92. This AND gate 92 receives the signals 98 and 104, supplied thereto, and executes the logical product operation on the input signals to produce an output signal 108. The AND gate 92 routes the so produced signal as a selection signal 108 to the selector circuit 96. When the logical level of the selection signal 108 is “1”, the selector circuit 96 selects the input signal 40 to output the signal as a composite sync signal 110. When the logical level of the selection signal 108 is “0”, the selection circuit 96 selects the input signal 42 to output the signal as the composite sync signal 110.

The operation of the selector 22 will now briefly be described with reference to FIG. 6. When the logical levels of the determination signals 76 and 80 are both “1”, the selector 96 delivers an output signal 98 of the logical level “1” to the AND gate 92. This output signal of the logical level “1” indicates that both the horizontal and vertical sync signals, contained in the output signal 40 (SC1), have been properly selected without signal dropout. Similarly, when the logical levels of the determination signals 78 and 82 are both “1”, the AND gate 90 delivers an output signal 102 of the logical level “1” to the inverter 94. This output signal of the logical level “1” indicates that both the horizontal and vertical sync signals, contained in the output signal 42 (SC2), have been properly selected without signal dropout. The inverter 94 delivers an output signal 104 of the logical level “0” to the AND gate 92.

The input conditions as well as the meanings thereof at this time will now be described. (1) When the logical levels of the output signals 98 and 104 are “0”, there is dropout in the sync signal in the output signal 40 (SC1), whereas there is no dropout in the sync signal in the output signal 42 (SC2). (2) When the logical level of the output signal 98 is “0” and the logical level of the output signal 104 is “1”, there is dropout in the sync signal in the output signals 40 (SC1) and 42 (SC2). (3) When the logical level of the output signal 98 is “1” and the logical level of the output signal 104 is “0”, there is no dropout in the sync signal in the output signal 40 (SC1) and in the output signal 42 (SC2). (4) When the logical levels of the output signals 98 and 104 are “1”, there is no dropout in the sync signal in the output signal 40 (SC1), whereas there is dropout in the sync signal in the output signal 42 (SC2).

Thus, under the condition (1), the selection circuit 96 selects and outputs the output signal 42 (SC2) in which there is no dropout in the sync signal. Under the condition (4), the selection circuit 96 selects and outputs the output signal 40 (SC1) in which there is no dropout in the sync signal. Under the condition (3), the selection circuit 96 may select either one of the output signals 40 (SC1) and 42 (SC2) because there is no dropout in the sync signal in the output signal 40 (SC1) or in the output signal 42 (SC2). In consideration of the circuit configuration shown in FIG. 6, however, the selection circuit 96 is adapted to select and output the output signal 42 (SC2). Under the condition (2), there is dropout in the sync signals in both the output signals 40 (SC1) and 42 (SC2). However, in the circuit configuration shown, the selection circuit 96 is adapted to select and output the output signal 42 (SC2).

In this manner, the selector 22 selects and outputs either one of the output signals 40 (SC1) and 42 (SC2) which includes no dropout in the sync signal. It is to be noted that the circuit configuration of the selector 22 is merely illustrative and that the circuit configuration of the selector may be optional to select, based on input signals 76, 78, 80 and 82, either of the output signals 40 (SC1) and 42 (SC2) in which there is no dropout in the sync signal.

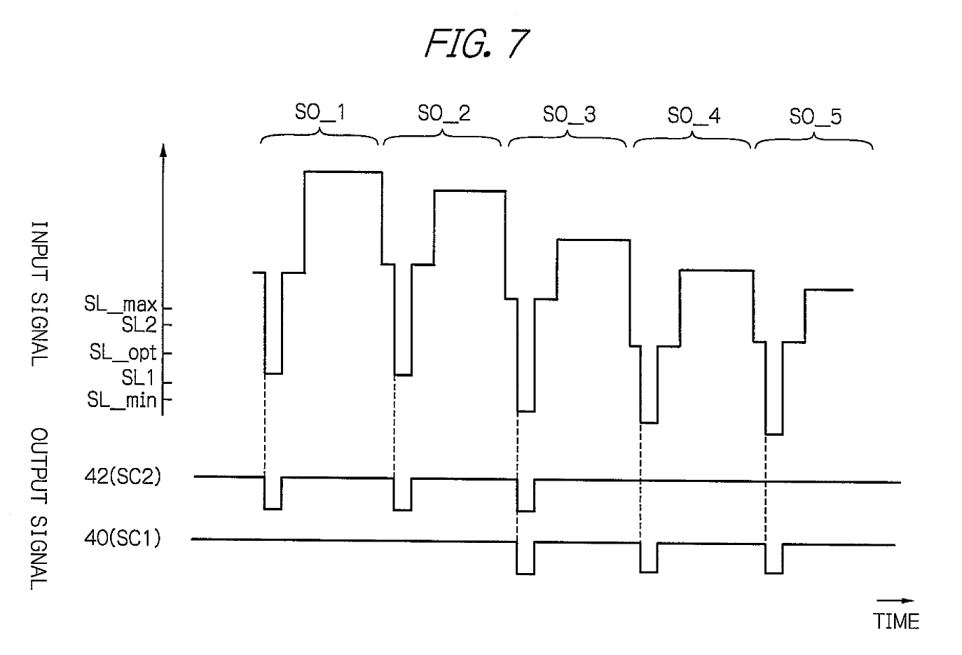

The operation of the sync separator 10 of the instant embodiment will now be described. Initially, composite video signals (SO_1) to (SO_5), having different sync chip levels from each other, as shown in FIG. 7, are supplied to the sync separator 10 in the form of input signals. Responsive to these signals, the comparator 16 of the sync separator 10 delivers the output signals 40 (SC1) and 42 (SC2). FIG. 7, showing the input signals (SO_1) to (SO_5) having different sync chip levels, is a diagram showing the relationships of reference signal levels with respect to the composite video signals (SO_1) to (SO_5) having different sync chip levels. In other words, FIG. 7 shows the relative intensity of the signal levels of the minimum level signal SL_min, reference level signal SL1, optimum reference level signal SL_opt, reference level signal SL2 and maximum level signal SL_max.

The optimum reference level signal SL_opt is practically a reference level signal capable of separating the composite sync signals from all of the composite video signals (SO_1) to (SO_5) having different sync chip levels.

In FIG. 7, if the reference signal level is set equal to the electric potential level of the reference level signal SL2, this electric potential level is at a mid level between the sync chip and pedestal levels of the composite video signals (SO_1) to (SO_3) and higher than the pedestal levels of the composite video signals (SO_4) and (SO_5). Hence, the comparator 16 is able to properly separate only the sync signals from the composite video signals (SO_1) to (SO_3), as indicated by the output signal 42 (SC2).

If the reference signal level is set equal to the electric potential level of the reference level signal SL1, this electric potential level is lower than the sync chip levels of the composite video signals (SO_1) and (SO_2) and is at a mid level between the sync chip levels and the pedestal levels of the composite video signals (SO_3) to (SO_5). Hence, the comparator 16 is able to properly separate only the sync signals from the composite video signals (SO_3) to (SO_5), as indicated by the output signal 40 (SC1).

In FIG. 7, the electric potential level of the reference level signal SL_opt is on a mid level between the sync chip levels and the pedestal levels of all of the composite video signals (SO_1) to (SO_5). Hence, if both the reference level signals SL1 and SL2 are set on the same electric potential level as the reference level signal SL_opt, it is possible to properly separate the sync signals from all of the composite video signals (SO_1) to (SO_5).

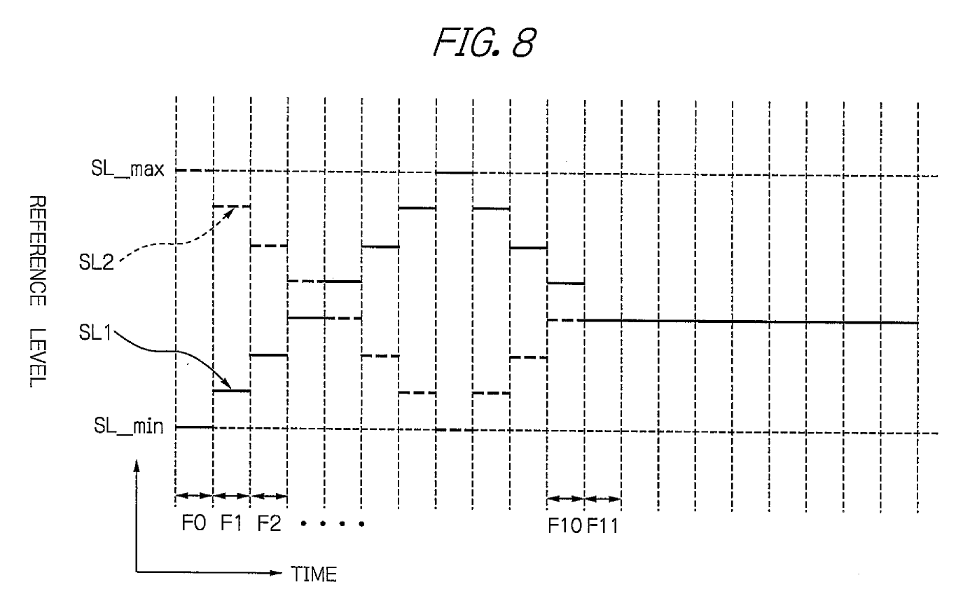

FIG. 8 is a timing chart showing an example of changes in the reference level signals SL1 and SL2. In the figure, the reference level signals SL1 and SL2 are changed each field period (F0, F1, F2, . . . ). During specified one of the field periods, each reference level signal is at a constant electric potential. The reference level signals SL1 and SL2 are set so as to sweep between the minimum level SL_min and the maximum level SL_max with respective different phase states. FIG. 8 shows an instance where the reference level signals SL1 and SL2 are out of phase by 180 degrees from each other. The reference level signals SL1 and SL2 are caused to be changed with respective different phase states in order for the signal level of either the reference level signal SL1 or SL2 to reach the optimum reference level signal SL_opt within a short time.

If only the reference level signal SL1 is used, there are occasions wherein it takes much time until the reference level signal reaches the optimum reference level signal SL_opt. That is, in case the composite sync level signal is changed as described above with reference to FIG. 7, and the reference level signal SL1 sweeps towards the bottom side in the figure, that is, in the direction away from the reference level signal SL_opt, it takes much time until the signal SL1 gets to the reference level signal SL_opt, as a result of which the sync signal cannot be obtained during such time. In the present embodiment, in which a couple of reference level signals are used, if the reference level signal SL1 sweeps towards the bottom side in the figure, the reference level signal SL2 sweeps in a direction towards the reference level signal SL_opt. Thus, a short time suffices until the signal level gets to the reference level signal SL_opt.

Meanwhile, the minimum level SL_min and the maximum level SL_max are determined on empirically in relation with the sync chip and pedestal levels of the composite sync signal of the composite sync signal.

Thus, with the sync separator 10 of the present embodiment, in which there are provided the reference level signals SL1 and SL2, the relative phase states of which are changed from one field period to another, either one of the reference level signals may get to the optimum reference level signal SL_opt within a shorter time. When the reference level signal has reached the optimum reference level signal SL_opt, it is determined by the horizontal sync determination circuit 50 and the vertical sync determination circuit 54 that there is no dropout in the sync signal, and the output signals 76 and 80, indicating the logical signal level of “1”, is fed back to the level controller 24, the level controller 24 sets the reference level signal SL1 at the then prevailing electric potential.

In a similar manner, when the reference level signal SL2 has reached the optimum reference level signal SL_opt, it is determined at the horizontal sync determination circuit 62 and the vertical sync determination circuit 66 that there is no dropout in sync signals, and output signals 78 and 82, indicating the logical signal level of “1”, are fed back to the level controller 24, the level controller 24 sets the reference level signal SL2 at the then prevailing electric potential. For example, in FIG. 8, the electric potential of the reference level signal SL2 is set at the potential during the field period F10, whereas the electric potential of the reference level signal SL is set at that during the field period F11.

The determination signals 76, 78, 80 and 82, indicating a possible dropout in the sync signals, are routed to the selector 22 as well. The selector 22 is responsive to the determination signals 76, 78, 80 and 82 to select the output signal 40 (SC1) or 42 (SC2) for which there is no dropout in the sync signal. Thus, the selector 22 selects the reference level signal SL1 or SL2, which has reached the optimum reference level more quickly, and outputs the so selected signal as a composite sync signal 110.

Thus, with the sync separator 10, in which two reference level signals are provided, used for separating the composite sync signal from the input composite video signal, and these two reference level signals are changed with different relative phase states from one field period to another, it is possible to generate the optimum sync signal 110 within a short period of time.

In the operational example, shown in FIG. 8, the reference level signals SL1 and SL2 are out of phase by 180 degree from each other. However, the present invention is not limited to this specific embodiment. It is sufficient that the reference level signals SL1 and SL2 exhibit phase difference, whereby it is possible to separate the composite sync signal in a shorter time than in case a sole reference level signal is used.

It is noted that, although the reference level signals SL1 and SL2 are fixed at the same value as from the field period F11, there are cases where dropout in the sync signal may again occur as from the field period F11, depending on fluctuations of the composite video signal. For such a case, the reference level signals SL1 and SL2 are desirably changed again so that there is a 180 degree phase difference between the reference level signals SL1 and SL2. By so doing, it becomes again possible to optimally separate the sync signal in a shorter time by either one of the reference level signals SL1 and SL2.

In the present embodiment, two reference level signals are used. However, those skilled in the art should be able to modify the embodiment using three or more reference level signals. For example, if three reference level signals are used, three feedback paths are provided in parallel from the level controller 24 to the comparator 16, in the configuration shown in FIG. 1, and the selector 22 is configured to select any one of three comparator outputs, for example, signals SC1, SC2 and SC3, which is free from dropout in the sync signal. With the use of three or more reference level signals, exhibiting phase differences from one another, it is possible to generate the proper composite sync signal within a still shorter time than if the two reference level signals are used.

An alternative embodiment of the sync separator 10 will now be described, embodying the sync separator of the present invention. Like component parts are indicated by the same reference numerals and the corresponding description will not be repeated. The sync separator 10 of the present alternative embodiment is featured by the configurations of the sync separation determiners 18 and 20, level controller 24 and selector 22. The sync separator 10 of the present alternative embodiment may be the same as the previous embodiment except that the alternative embodiment does not having elements corresponding to the vertical sync separation circuits 52 and 64 and the vertical sync determination circuits 54 and 66. The sync separator 10 includes, in its sync separation determiners 18 and 20, horizontal sync separation circuits 48 and 60, and horizontal sync determination circuits 50 and 62. To enable separation of the composite sync signals in a remarkably short time, the sync separator 10 causes reference level signals 32 (SL1) and 34 (SL2) to be changed from one horizontal line period to another. The reference level signals 32 (SL1) and 34 (SL2), supplied from the level control circuits 84 and 86 of the level controller 24 to the comparison circuits 36 and 38, respectively, are changed every frame period.

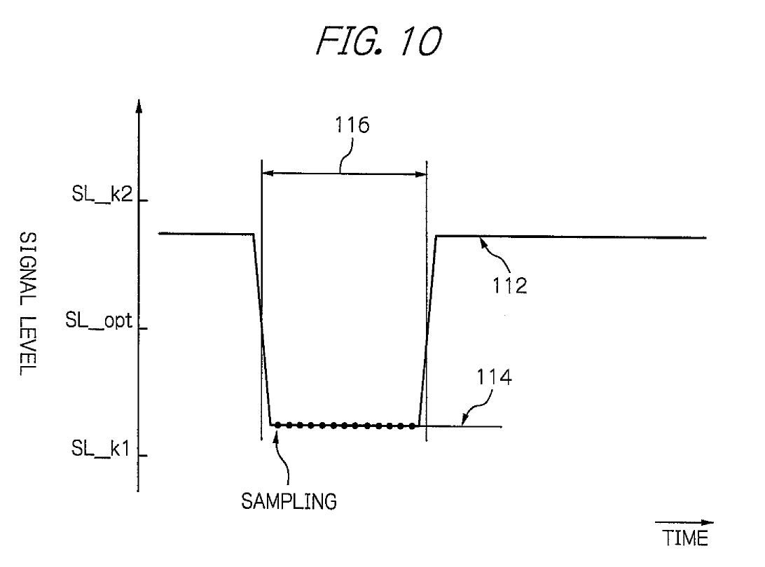

Referring then to FIG. 10, the principle of determining possible dropout in the horizontal sync signal in the sync separator 10 will be described. In general, the period of a horizontal sync signal is defined by a period corresponding to the number of times of sampling the pedestal level of a composite video signal at a sampling frequency, and is set to be in a range S_PD, not shown. The period of the horizontal sync signal is prescribed to be 4.7±0.1 μs under, e.g. the SMPTE (Society of Motion Picture and Television Engineers) 170M standard.

The horizontal sync separation circuits 48 and 60 route the so separated horizontal sync signals 68 (SH1) and 72 (SH2) to the horizontal sync determination circuits 50 and 62, respectively.

If the number of times of sampling of the electric potentials of the horizontal sync signals 68 (SH1) and 72 (SH2) lower than the reference level signal SL1 or SL2 falls within this range S_PD, the reference level signals SL1 and SL2 may be determined to properly separate composite sync signals 40 (SC1) and 42 (SC2) that are output from the comparator circuits 36 and 38, respectively.

For example, in FIG. 10, if the reference level signal is at an electric potential of SL_opt, and hence is in an intermediate electric potential range between the pedestal level 112 and the sync chip level 114 of the separated horizontal sync signal, the number of times of sampling of the electric potential lower than the reference level signal is confined to be in a period 116. The number of times of sampling confined in the period 116 is comprised within the range S_PD. By contrast, if the electric potential of the reference level signal is in an electric potential range higher than the pedestal level 112 of the separated horizontal sync signal, e.g. at a signal level SL_k2, FIG. 10, the number of times of sampling of the electric potential lower than the reference level signal as set is increased appreciably. That is, the number of times of sampling under this condition exceeds the range S_PD.

If the electric potential of the reference level signal is in a potential range lower than the sync chip level of the separated horizontal sync signal, that is, at SL_k1, the number of times of sampling of the electric potential lower than the reference level signal as set becomes significantly small. That is, the number of times of sampling under this condition is less than the range S_PD.

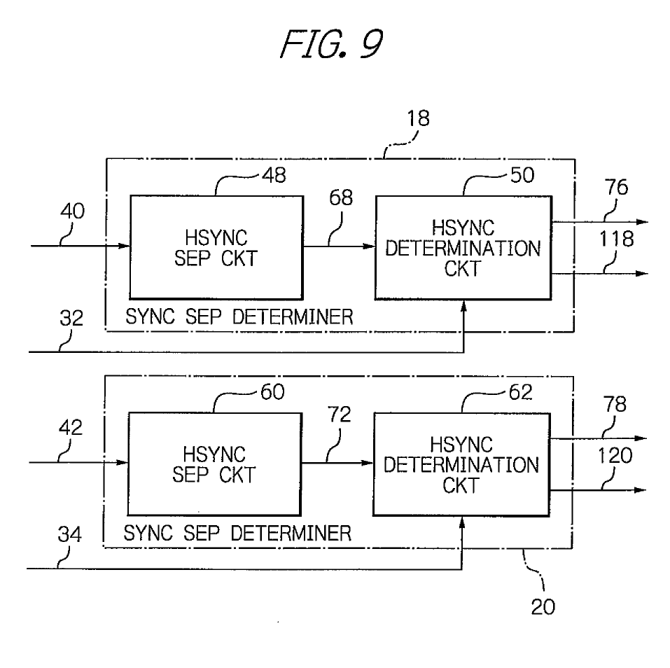

Referring again to FIG. 9, the horizontal sync determination circuit 50 counts the number of times of sampling of the electric potential of the horizontal sync signal 68 (SH1) less than the number of the reference level signal 32 (SL1), supplied from the level control circuit 84, and transmits an output signal 118, indicating the count, to the level control circuit 84.

The horizontal sync determination circuit 50 also determines possible substantial dropout in the sync signal in the horizontal sync signal 68 (SH1) from one line period to another. When the horizontal sync determination circuit 50 has determined that there is no dropout in the sync signal, the determination circuit 50 sets the logical level of the determination signal 76 to “1” to output the signal to the selector 22. When the horizontal sync determination circuit 50 has determined that there is dropout in the sync signal, the determination circuit 50 sets the logical level of the determination signal 76 to “0” to output the signal to the selector 22.

The horizontal sync determination circuit 62 also counts the number of times of sampling of the electric potential of the horizontal sync signal 72 (SL2) less than the number of the reference level signal 34 (SL2), supplied from the level control circuit 86, and transmits an output signal 120, indicating the count, to the level control circuit 86. The horizontal sync determination circuit 62 also determines possible substantial dropout in the sync signal in the horizontal sync signal 72 (SH2) from one line period to another. When the horizontal sync determination circuit 62 has determined that there is no dropout in the sync signal, the horizontal sync determination circuit 62 sets the logical level of the determination signal 78 to “1” to output the signal to the selector 22. When the horizontal sync determination circuit 62 has determined that there is dropout in the sync signal, the determination circuit 62 sets the logical level of the determination signal 78 to “0” to output the signal to the selector 22.

Meanwhile, the method for determination according to the present invention is not limited to the specific one which relies upon whether or not the number of times of counting less then the number of the reference level signals SL1 is within the predetermined range S_PD. That is, the method for determination may be any of methods known to those skilled in the art.

The level control circuit 84 receives the output signal 118 of the horizontal sync determination circuit 50 to change or control the reference level signal 32 (SL1) supplied to the comparison circuit 36. That is, the sync separating circuit 10 causes a resultant count of the horizontal sync determination circuit 50 to be fed back to enable the comparator circuit 36 to properly select the composite sync signal.

In more detail, the level control circuit 84 causes the reference level signal SL1 to be lowered a predetermined amount under a condition in which the count represented by the output signal 118 resulting from the counting exceeds the predetermined range S_PD. This condition is valid when the reference level signal SL1 is in a first potential range higher than the pedestal level of the horizontal sync signal 68 (SH1) separated by the horizontal sync separation circuit 48.

Under a condition in which the counting results are less than the predetermined range S_PD, the level control circuit 84 causes the reference level signal SL1 to be increased a predetermined amount. This condition is valid when the reference level signal SL1 is in a second electric potential range lower than the sync chip level of the horizontal sync signal 68 (SH1) separated by the horizontal sync separation circuit 48.

The level control circuit 86 is supplied with the output signal 120 of the horizontal sync determination circuit 62 to change the reference level signal 34 (SL2) supplied to the comparator circuit 38. That is, the sync separator 10 causes the counting result to be fed back to permit proper separation of the composite sync signal in the comparator circuit 38.

Specifically, the level control circuit 86 causes the reference level signal SL2 to be lowered a predetermined mount under a condition in which the counting result indicated by the output signal 120 exceeds the predetermined range S_PD. This condition is valid when the reference level signal SL2 is in a third electric potential range higher than the pedestal level of the horizontal sync signal 72 (SH2) separated by the horizontal sync separation circuit 60. Also, under a condition in which the counting result is below the predetermined range S_PD, the level control circuit 86 causes the reference level signal SL2 to be increased a predetermined mount. This condition is valid when the reference level signal SL2 is in a fourth electric potential range lower than the sync chip level of the horizontal sync signal 72 (SH2) separated by the horizontal sync separation circuit 60.

Preferably, the initial value of the reference level signal SL2 differs from that of the reference level signal SL1.

The selector 22 selects either of the composite sync signals 40 (SC1) and 42 (SC2), produced by the comparison circuits 36 and 38, respectively, as a proper composite sync signal. The selector 22 outputs the selected composite sync signal 110.

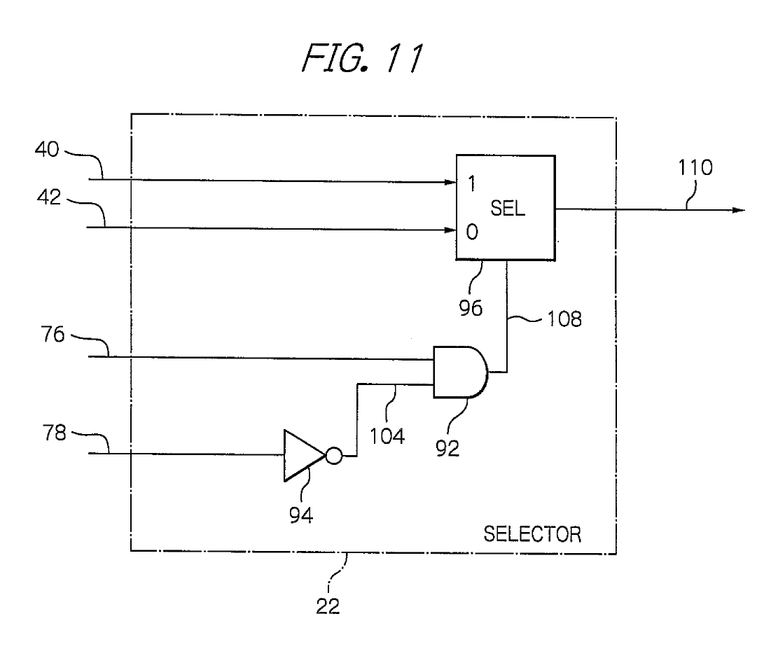

The circuit configuration of the selector 22 of the present alternative embodiment will now be described. In the alternative embodiment, like components are of course designated with the same reference numerals. In the sync separating circuit 10 of the alternative embodiment, only the result of determination for the horizontal sync signal is used for selection of the proper composite sync signal. Hence, the selector 22 shown in FIG. 11 does not include components corresponding to the AND gates 88 and 90 shown in FIG. 6. In other respects, the selector 22 shown in FIG. 11 is of the same configuration as the selector 22 shown in and described with reference to FIG. 6.

The logical levels of the determination signals 76 and 78, supplied in FIG. 11, become “1” in case the horizontal sync signals contained in the output signals 40 (SC1) and 42 (SC2) suffer no dropout and have been separated properly. Thus, in the sync separating circuit 10, the input conditions and the meanings of the determination signal 76 and an inverted version 104 of the determination signal 78 are the same as in the selector 22.

Specifically, (1) When the logical levels of the determination signals 76 and 104 are “0”, there is dropout in the sync signal in the output signal 40 (SC1), whereas there is no dropout in the sync signal in the output signal 42 (SC2). (2) When the logical level of the output signal 76 is “0” and the logical level of the output signal 104 is “1”, there is dropout in the sync signals in the output signals 40 (SC1) and 42 (SC2). (3) When the logical level of the output signal 76 is “1” and the logical level of the output signal 104 is “0”, there is no dropout in the sync signal in the output signals 40 (SC1) and 42 (SC2). (4) When the logical levels of the output signals 76 and 104 are “1”, there is no dropout in the sync signal in the output signals 40 (SC1), whereas there is dropout in the sync signal in the output signal 42 (SC2).

Thus, under the condition (1), the selection circuit 96 selects and outputs the output signal 42 (SC2) in which there is no dropout in the sync signal. Under the condition (4), the selection circuit 96 selects and outputs the output signal 40 (SC1) in which there is no dropout in the sync signals. Under the condition (3), the output signal 40 (SC1) or 42 (SC2) may be selected, because none of these signals suffers dropout in the sync signal. In the specific circuit configuration shown in FIG. 11, however, the selection circuit 96 is adapted to select and output the output signal 42 (SC2). Under the condition (2), both the output signals 40 (SC1) and 42 (SC2) suffer dropout in the sync signals. In the circuit configuration thus shown, also, the selection circuit 96 selects and outputs the output signal 42 (SC2).

In this manner, the selector 22 selects and outputs either one of the output signals 40 (SC1) and 42 (SC2) which suffers no dropout in the sync signal. It should be noted however that the circuit configuration of the selector 22 shown in FIG. 11 is merely illustrative and the circuit configuration may be selected in such a manner that the output signal 40 (SC1) or 42 (SC2) that suffers no dropout in the sync signal will be selected based on the input signals 76, 78, 80 and 82.

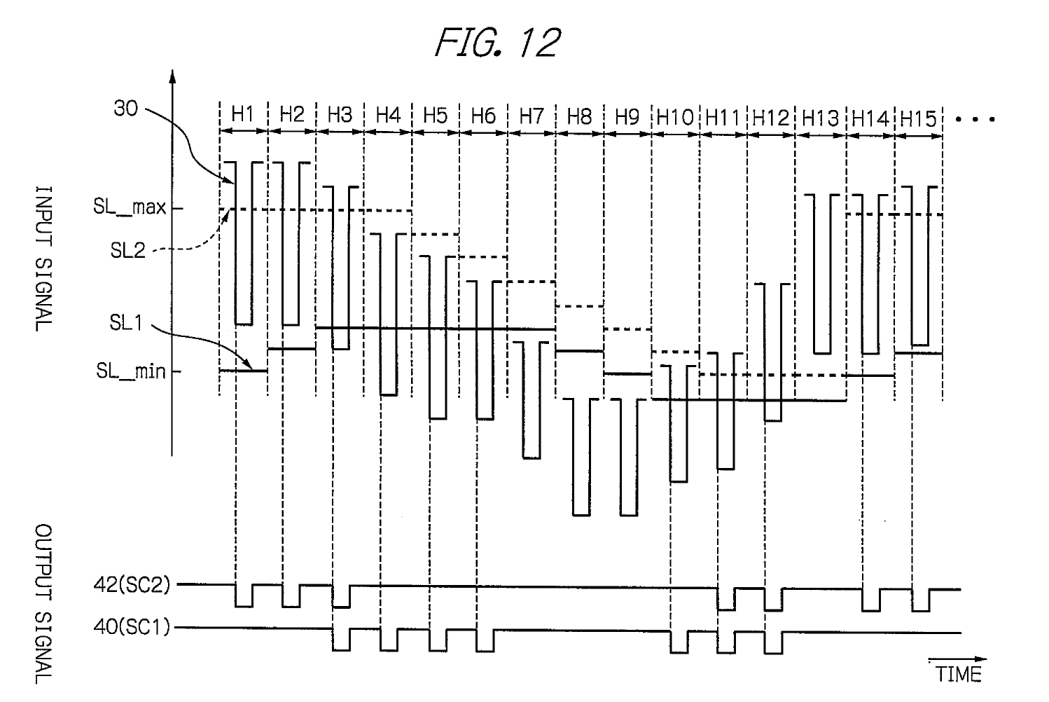

The operation of the sync separator 10 of the present alternative embodiment will now be described. The composite video signals 30, different in sync chip level from each other, are supplied as input signals to the comparison circuits 36 and 38 of the comparator 16, as shown in FIG. 12. This figure shows the sync signals of the composite video signal 30 and, more specifically, the locations of the reference level signals SL2 and SL1 with respect to respective sync signals. The comparator 16 is responsive to these input signals to output the output signals 40 (SC1) and 42 (SC2). The output signals 40 (SC1) and 42 (SC2) indicate changes on a line period basis in the horizontal sync signal for the line periods H1, H2, . . . , H15, . . . . Also, in the figure, the initial value of the reference level signal SL1 is set to the minimum level SL_min, whereas the initial value of the reference level signal SL2 is set to the maximum level SL_max.

In this operational example, it is assumed that the composite video signal 30 has been produced on demodulation of television broadcast signals (electro-magnetic waves) received in, e.g. a territory of weak electric field, and that the so produced signals fluctuate with time. During the line periods H1 to H3, the reference level signal SL2 is at an electric potential intermediate between the pedestal and sync chip levels of the composite video signal 30. Hence, the output signal 42 (SC2) is properly separated as a composite sync signal. During the line periods H1 to H3, the counting result 120, output from the horizontal sync determination circuit 62, is within the predetermined range S_PD. Hence, the level control circuit 86 does not cause the level of the reference level signal SL2 to be changed during the line periods H2 to H4 in which the counting results 120 are to be reflected.

During the next line periods H4 to H10, the reference level signal SL2 is at an electric potential higher than the pedestal level of the composite video signal 30. Hence, the output signal 42 (SC2) is not properly separated as the composite sync signal. During these line periods H4 to H10, a resultant count value 120, output from the horizontal sync determination circuit 62, exceeds the predetermined range S_PD. Thus, in the line periods H5 to H11, in which the counting results are reflected, the level control circuit 86 causes the level of the reference level signal SL2 to be lowered the predetermined amount from one line period to another.

Also, in the line periods H1 and H2, the reference level signal SL1 is at an electric potential lower than the sync chip level of the composite video signals 30. The comparison circuit 36 is unable to properly separate the output signal 40 (SL1) as the composite sync signal. During these line periods H1 and H2, a resultant count value 118, output from the horizontal sync determination circuit 50, is less than the predetermined range S_PD. Thus, in the line periods H2 and H3, in which the counting results 118 are reflected, the level control circuit 84 causes the level of the reference level signal SL1 to be increased the predetermined amount from one line period to another.

Next, in the line periods H3 to H6, since the reference level signal SL1 is at an electric potential intermediate between the pedestal and sync chip levels of the composite video signals 30, the output signal 40 (SC1) is properly separated as the composite sync signal. During these periods H3 to H6, the counting results 118, output from the horizontal sync determination circuit 50, fall within the predetermined range S_PD. Hence, the level control circuit 84 does not cause the level of the reference level signal SL2 to be changed during the line periods H4 to H7 when the counting results 118 are reflected.

Next, during the line periods H7 to H9, the reference level signal SL1 is at an electric potential higher than the pedestal level of the composite video signal 30. Hence, the output signal 40 (SC1) is not properly separated as a composite sync signal. During these line periods H7 to H9, the resultant count value 118, output from the horizontal sync determination circuit 50, exceeds the predetermined range S_PD. Hence, the level control circuit 84 causes the level of the reference level signal SL1 to be lowered a predetermined amount, from one line period to another, during the line periods H8 to H10 when the counting results 118 are to be reflected.

During the next line periods H11 and H12, both the counting results 118 and 120, supplied from the horizontal sync determination circuits 50 and 62, are within the predetermined range S_PD. Thus, the output signals 40 (SC1) and 42 (SC2) may properly be separated as the composite sync signal.

Thus, with the sync separator 10 of the alternative embodiment, the composite sync signal may properly be separated by either one of the comparison circuits 36 and 38, except during the line periods H7 to H9, as seen from FIG. 12. The comparison circuits 36 and 38 select either one of the output signals 40 (SC1) and 42 (SC2), which is proper as the sync signal, by the selector 22, the selector then outputting the thus selected signal in the form of composite sync signal 110.

In order to improve separability within a shorter time of the composite sync signal by either one of the reference level signals SL1 and SL2, it is desirable to set the initial values of the reference level signals SL1 and SL2 at the minimum level SL_min and the maximum level SL_max, as shown in FIG. 12. The minimum level SL_min and the maximum level SL_max are empirically predetermined responsive to the actual values of fluctuations of the sync chip and pedestal levels of the composite sync signal.

Continuing to refer to FIG. 12, during the line periods H11 and H12, both the reference level signals SL1 and SL2 are at an electric potential level intermediate between the pedestal and sync chip levels of the composite video signal 30. In the next line period H13, the horizontal sync determination circuits 50 and 62 give the determination that there is no dropout in the sync signal during these line periods, and then, the determination circuits 50 and 62 give the determination that there is dropout in both the sync signals. However, in the line period H14 when these results are reflected, the level control circuits 84 and 86 restore the reference level signals SL1 and SL2 to their initial values. In this case, the level control circuits 84 and 86 determine a possible dropout in the sync signal depending on whether or not the count value indicated by the supplied output signals 118 and 120 is within the predetermined range S_PD. However, the level control circuits 84 and 86 may directly receive the result of determination of the horizontal sync determination circuits 50 and 62, that is, the determination signals 76 and 78, without relying upon the count values supplied.

In case the reference level signals SL1 and SL2 are substantially on the same electric potential level, such as during the line periods SL1 and SL2, FIG. 12, if the reference level signals SL1 and SL2 were caused to follow the fluctuations in the composite video signals, then the operating state would be in no way different from the case where the sole channel reference level signal is used. In such a case, it would be difficult to optimally separate the sync signal within a short time. It is therefore desirable in such a case to restore the reference level signals SL1 and SL2 to respective different initial values to improve the follow-up characteristics of the reference level signals SL1 and SL2 against fluctuations in the composite video signals 30.

In short, with the sync separator 10 of the alternative embodiment, there are provided a couple of reference level signals for separating the composite sync signal from the input composite video signal which are different in initial value from each other and changed in level from one line period to another such as to follow fluctuations in the composite video signal. Thus, the proper composite sync signal 110 may be produced in a still shorter time than with the previous embodiment.

The entire disclosure of Japanese patent application No. 2006-300455 filed on Nov. 6, 2006, including the specification, claims, accompanying drawings and abstract of the disclosure is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A sync separator for separating a sync signal from a composite video signal, comprising:
a comparator for extracting first and second composite sync signals with respect to first and second reference levels for the composite video signal;
a first sync separation determiner for separating a sync signal of one of the composite sync signals extracted, and determining whether or not there is dropout in the sync signal separated to develop a result of determination as a first separation determination signal;
a second sync separation determiner for separating a sync signal of another of the composite sync signals extracted, and determining whether or not there is dropout in the sync signal separated to develop a result of determination as a second separation determination signal;
a level controller responsive to the first and second separation determination signals for generating first and second reference levels to supply the first and second reference levels produced to said comparator; and
a selector responsive to the two separation determination signals for selecting either one of the first and second composite sync signals to output the one composite sync signal selected;
said level controller causing the second reference level to be sequentially changed so that a phase state of the second reference level will be different from a phase state of the first reference level, fixedly setting the first and second reference levels responsive to normal separation of the sync signal, and causing the reference level suffering from dropout in the sync signal to be changed responsive to the dropout in the sync signal.

2. The sync separator in accordance with claim 1, wherein said level controller causes the first and second reference levels to be changed so that the first and second reference levels will be out of phase by 180 degrees relative to each other.

3. The sync separator in accordance with claim 2, wherein said level controller fixedly sets both of the first and second reference levels, and there after said first and second sync separation determiners re-set the first and second reference levels, responsive to determination that both of the first and second reference levels suffer from dropout in the sync signal, so that the first and second reference levels will be out of phase by 180 degrees relative to each other.

4. The sync separator in accordance with claim 1, wherein said first sync separation determiner includes:
a first horizontal sync separation circuit for separating a horizontal sync signal of each field from the one composite sync signal;
a first vertical sync separation circuit for separating a vertical sync signal of each field from the one composite sync signal;
a first horizontal determination circuit for determining possible dropout in the horizontal sync signal separated to produce a first determination signal; and
a first vertical determination circuit for determining possible dropout in the vertical sync signal separated to produce a second determination signal;
the first and second determination signals being output as a first separation determination signal to said selector and said level controller;
said second sync separation determiner including:
a second horizontal sync separation circuit for separating a horizontal sync signal of each field from the other composite sync signal;
a second vertical sync separation circuit for separating a vertical sync signal of each field from the other composite sync signal;
a second horizontal determination circuit for determining possible dropout in the horizontal sync signal separated to produce a third determination signal; and
a second vertical determination circuit for determining possible dropout in the vertical sync signal separated to produce a fourth determination signal;
the third and fourth determination signals being output as a second separation determination signal to said selector and said level controller.

5. The sync separator in accordance with claim 1, wherein said first sync separation determiner includes:
a first horizontal sync separation circuit for separating a horizontal sync signal of each field from the one composite sync signal; and
a first horizontal determination circuit for determining possible dropout in the horizontal sync signal separated to produce a first determination signal;
the first determination signal being output as a first separation determination signal to said selector;
said second sync separation determiner including:
a second horizontal sync separation circuit for separating a horizontal sync signal of each field from the other composite sync signal; and
a second horizontal determination circuit for determining possible dropout in the horizontal sync signal separated to produce a second determination signal;
the second determination signal being output as a second separation determination signal to said selector.

6. The sync separator in accordance with claim 1, wherein said level controller includes:
a first control circuit exercising control for decreasing the first reference level a predetermined amount responsive to a determination that the first reference level is in a first potential region higher than a pedestal level of the horizontal sync signal, and for increasing the first reference level a predetermined amount responsive to a determination that the first reference level is in a second potential region lower than a sync chip level of the horizontal sync signal; and
a second control circuit exercising control for decreasing the second reference level a predetermined amount responsive to a determination that the second reference level is in a third potential region higher than the pedestal level of the horizontal sync signal, and for increasing the second reference level a predetermined amount responsive to a determination that the first reference level is in a fourth potential region lower than the sync chip level of the horizontal sync signal.

7. The sync separator in accordance with claim 6, wherein said first control circuit determines, based on a number of times of sampling of the horizontal sync signal, at an electric potential lower than the first reference level, whether the first reference level is in the first potential region or in the second potential region, said first control circuit being responsive to the result of determination to exercise control to change the first reference level from one horizontal line period to another;
said second control circuit determining, based on the number of times of sampling of the horizontal sync signal, at an electric potential lower than the second reference level, whether the second reference level is in the third potential region or in the fourth potential region, said second control circuit being responsive to the result of determination to exercise control to change the first reference level from one line period to another.

8. The sync separator in accordance with claim 6, further comprising:
a first horizontal sync separation circuit for separating the horizontal sync signal of each field from the one composite sync signal; and
a first horizontal determination circuit for determining possible dropout in the horizontal sync signal separated to produce a first determination signal;
a second horizontal sync separation circuit for separating the horizontal sync signal of each field from the other composite sync signal; and
a second horizontal determination circuit for determining possible dropout in the horizontal sync signal separated to produce a second determination signal;
said first and second control circuits fixedly setting the first and second reference levels to initial values responsive to determination by said first and second horizontal determination circuits that there is dropout in the horizontal sync signal subsequent to determination that the horizontal sync signal has been separated normally.
